(19) United States
(12) Patent Application Publication
(10) Pub. No.: US 2025/0220300 A1
(43) Pub. Date: Jul. 3, 2025

(54) WIRELESS SMART WEARABLE DEVICE AND IMAGE ACQUISITION METHOD THEREOF

(71) Applicant: Bestechnic (Shanghai) Co., Ltd., Shanghai (CN)

(72) Inventors: Weifeng Tong, Shanghai (CN); Mingliang Xu, Shanghai (CN); Hua Zeng

(73) Assignee: Bestechnic (Shanghai) Co., Ltd., Shanghai (CN)

(21) Appl. No.: 19/086,867

(22) Filed: Mar. 21, 2025

Related U.S. Application Data
(63) Continuation of application No. PCT/CN2023/103757, filed on Jun. 29, 2023.

(30) Foreign Application Priority Data
Sep. 22, 2022 (CN) 202211159526.5

(51) Int. Cl. H04N 23/66; H04N 23/698; H04N 23/71; H04N 23/73; H04N 23/90; H04W 4/80; H04W 56/00

(52) U.S. Cl. CPC H04N 23/66; H04N 23/71; H04N 23/73; H04N 23/90; H04W 56/002; H04N 23/698; H04W 4/80

(57) ABSTRACT

A wireless smart wearable device includes a first portion and a second portion that can communicate with each other wirelessly. The first portion and the second portion respectively includes a first processor and a second processor, a first wireless communication module and a second wireless communication module, a first camera and a second camera, a first image acquisition module and a second image acquisition module, and a first clock and a second clock. The first image acquisition module transmits a first hardware trigger signal based on the first clock to the first camera, and the second image acquisition module transmits a second hardware trigger signal based on the second clock to the second camera. At least one processor enables the first wireless communication module and the second wireless communication module to continuously perform wireless communication with each other and/or wireless communication between both of them and a smart device, and determines a clock difference to achieve synchronization between the first and second hardware trigger signals.

### CROSS-REFERENCE TO RELATED APPLICATIONS

application is a continuation of International Application No. This PCT/CN2023/103757, filed on Jun. 29, 2023, which claims the benefit of priority to Chinese Application No. 202211159526.5, filed on Sep. 22, 2022, both of which are incorporated herein by reference in their entireties.

### TECHNICAL FIELD

The present application relates to a wireless device and an image acquisition method, and more specifically, to a wireless smart wearable device and an image acquisition method thereof.

### BACKGROUND

Smart wearable devices, such as smart glasses and smart watches, are gradually becoming integrated into people's work and lives. These smart wearable devices are connected to each other and to other smart devices (such as mobile phones, pads, personal computers, and multimedia TVs) via wireless means.

With the development of user demands, these smart wearable devices are usually provided with multiple cameras at multiple locations (such as left and right eyeglass portions of smart glasses), and provide various video-related functions, such as augmented reality, virtual reality, and panoramic view. These functions require the plurality of cameras to synchronously acquire videos or images. However, there is an issue of insufficient synchronization accuracy in current video or image capture by individual cameras. For example, if the videos or images acquired by the plurality of cameras need to be stitched together to generate a panoramic video, defects such as image blur and motion ghosting will occur, negatively impacting the user experience.

### SUMMARY

The present application is provided to solve the technical problems existing in the prior art.

The present application aims to provide a wireless smart wearable device and an image acquisition method thereof, which enables multiple cameras provided in multiple sections of the wireless smart wearable device to achieve dynamic and precise synchronization of image capture and acquisition in a hardware-triggered manner.

According to a first aspect of the present application, a wireless smart wearable device is provided. The wireless smart wearable device includes a first portion and a second portion that can communicate with each other wirelessly. The first portion includes a first processor, a first wireless communication module, a first camera, and a first image acquisition module, and has a first clock. The second portion includes a second processor, a second wireless communication module, a second camera, and a second image acquisition module, and has a second clock. The first image acquisition module is configured to transmit a first hardware trigger signal based on the first clock to the first camera so as to trigger the first camera to capture a first image, and acquire the first image. The second image acquisition module is configured to transmit a second hardware trigger signal based on the second clock to the second camera so as to trigger the second camera to capture a second image, and acquire the second image. At least one of the first processor and the second processor is configured to, during the continuous use of the first image acquisition module and the second image acquisition module, enable the first wireless communication module and the second wireless communication module to perform wireless communication with each other and/or wireless communication between both of them and a smart device, and determine a clock difference between the first wireless communication module and the second wireless communication module in performing the wireless communication respectively, the clock difference being used to achieve synchronization between the first hardware trigger signal and the second hardware trigger signal.

According to a second aspect of the present application, an image acquisition method for a wireless smart wearable device is provided. The wireless smart wearable device includes a first portion and a second portion that can communicate with each other wirelessly. The first portion includes a first processor, a first wireless communication module, a first camera, and a first image acquisition module, and has a first clock. The second portion includes a second processor, a second wireless communication module, a second camera, and a second image acquisition module, and has a second clock. The image acquisition method includes the following steps: During the continuous use of the first image acquisition module and the second image acquisition module, enabling the first wireless communication module and the second wireless communication module to perform wireless communication with each other and/or wireless communication between both of them and a smart device, and determining a clock difference between the first wireless communication module and the second wireless communication module in performing the wireless communication respectively. Transmitting, by the first image acquisition module, a first hardware trigger signal based on the first clock to the first camera so as to trigger the first camera to capture a first image, and acquiring the first image. Transmitting, by the second image acquisition module, a second hardware trigger signal based on the second clock to the second camera so as to trigger the second camera to capture a second image, and acquiring the second image. Wherein synchronization between the first hardware trigger signal and the second hardware trigger signal is achieved by using the clock difference.

By using the wireless smart wearable device and the image acquisition method thereof according to the present application, which enables multiple cameras disposed at multiple sections of the wireless smart wearable device to achieve dynamic and precise synchronization of image capture and acquisition in a hardware-triggered manner.

### BRIEF DESCRIPTION OF THE DRAWINGS

In figures that are not necessarily drawn to scale, the same reference numerals may describe similar components in different figures. The same reference signs with suffixes or different suffixes may denote different examples of similar components. The figures generally show various embodiments by way of example rather than limitation, and are used together with the description and the claims to describe the embodiments of the present disclosure. As proper, the same reference sign may be used throughout the drawings to denote the same or similar part. Such embodiments are illustrative, and are not intended to be exhaustive or exclusive embodiments of the present device or method.

FIG. 1 illustrates a structural schematic diagram of a wireless smart wearable device according to a first embodiment of the present application;

FIG. 2 illustrates a schematic diagram of a synchronization control method for image capture and acquisition of different cameras in a wireless smart wearable device according to a second embodiment of the present application;

FIG. 3 illustrates a schematic diagram of a synchronization control method for image capture and acquisition of different cameras in a wireless smart wearable device according to a third embodiment of the present application;

FIG. 4 illustrates a schematic diagram of a synchronization control method for image capture and acquisition of different cameras in a wireless smart wearable device according to a fourth embodiment of the present application;

FIG. 5 illustrates a schematic diagram of a synchronization control method for image capture and acquisition of different cameras in a wireless smart wearable device according to a fifth embodiment of the present application;

FIG. 6 illustrates a timing diagram of a hardware trigger signal for triggering different cameras to perform image capture and acquisition according to a sixth embodiment of the present application;

FIG. 7 illustrates a flowchart of an image acquisition method for a wireless smart wearable device according to a seventh embodiment of the present application;

FIG. 8 illustrates a flowchart of an image acquisition method for a wireless smart wearable device according to an eighth embodiment of the present application;

FIG. 9 illustrates a timing diagram of a SOT or EOT signal according to a ninth embodiment of the present application;

FIG. 10 illustrates a structural schematic diagram of a wireless smart wearable device according to a tenth embodiment of the present application; and

FIG. 11 illustrates a flowchart of an image acquisition method for a wireless smart wearable device according to an eleventh embodiment of the present application.

### DETAILED DESCRIPTION

In order to enable those skilled in the art to better understand the technical solutions of the present application, the present application is described in detail below in conjunction with the accompanying drawings and specific embodiments. The embodiments of the present application are further described in detail below in conjunction with the accompanying drawings and specific embodiments, but are not to be construed as limiting the present application. For various steps described herein, if there is no necessary sequential relationship between each other, the order in which the steps are described as examples herein should not be considered as a limitation. Those skilled in the art will understand that the sequence of the steps may be adjusted as long as such adjustments do not disrupt the logical relationships between them and render the overall process unworkable. The expressions “first”, “second” and “third” in the present application are merely intended for descriptive distinction and do not mean any limitation on quantity or sequence, nor are they intended to limit the differences in physical properties of the elements, devices and systems following the expressions “first”, “second” and “third”. For example, a “first system on chip” may include a system implemented on a single chip, and may also include (one or more) systems implemented on a plurality of chips.

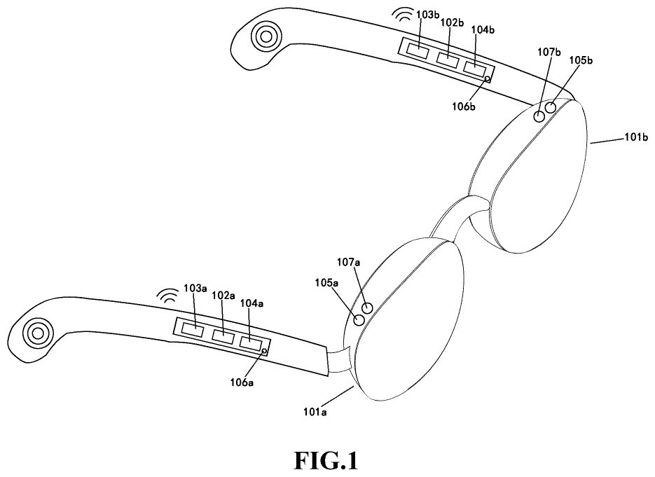

FIG. 1 illustrates a structural schematic diagram of a wireless smart wearable device according to a first embodiment of the present application. The wireless smart wearable device may include a first portion 101a and a second portion 101b that can communicate with each other wirelessly. As an example, 8 illustrates a wireless smart glasses device as an example of the wireless smart wearable device in, one of the first portion 101a and the second portion 101b is a left eyeglass portion and the other is a right eyeglass portion, which however is merely an example. The wireless smart wearable device may adopt other configurations and may even be formed as an assembly including two or more separate components (devices), as long as each component is provided with its own camera and it is necessary to synthesize images or videos from the respective camera. For example, the wireless smart wearable device may include a wireless smart helmet, a wireless smart bracelet, etc., or may include assemblies of a wireless smart necklace and a wireless smart bracelet, etc.

The following description is made by taking a wireless smart glasses device as an example. The following description may also be flexibly applied specifically to wireless smart wearable devices of other configurations, which will not be elaborated here.

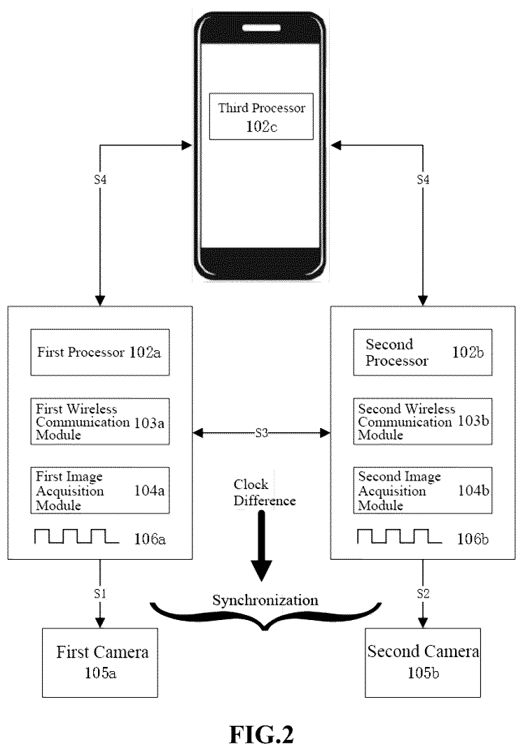

As shown in FIGS. 1 and 2, the first portion 101a includes a first processor 102a, a first wireless communication module 103a, a first camera 105a, and a first image acquisition module 104a, and has a first clock 106a, and the second portion 101b includes a second processor 102b, a second wireless communication module 103b, a second camera 105b, and a second image acquisition module 104b, and has a second clock 106b. As an example, the first camera 105a and the second camera 105b are respectively provided at left and right sides of an upper beam of a glasses frame, so that the captured images/videos can contain surrounding environment information within the user's field of view as much as possible. In some embodiments, the first processor 102a, the first wireless communication module 103a, the first image acquisition module 104a and the first clock 106a are built into a temple of the first portion 101a (shown as the right eyeglass portion in FIG. 1), while the second processor 102b, the second wireless communication module 103b, the second image acquisition module 104b and the second clock 106b are built into a temple of the second portion 101b (shown as the left eyeglass portion in FIG. 1). Usually, the first portion 101a and the second portion 101b are wirelessly connected. The first clock 106a and the second clock 106b belong to two separate portions. Although they may have the same nominal frequency, each is based on a different crystal or crystal oscillator, and their respective crystals or crystal oscillators often exhibit a certain frequency offset, for example, within 10 ppm, 5 ppm, or 1 ppm. Moreover, the start values of timers of the first clock 106a and the second clock 106b may also have deviations.

In some embodiments, the first clock 106a may belong to the first wireless communication module 103a, and the second clock 106b may belong to the second wireless communication module 103b. For example, if the first wireless communication module 103a is a Bluetooth communication module 103a, its own Bluetooth clock can be used as the first clock 106a.

The first clock 106a may be characterized by a first clock counter or a first unit of clock counter, and the second clock 106b may be characterized by a second clock counter or a second unit of clock counter. Since the counting start time points of the first clock counter and the second clock counter may be different, even the initial values may be different, and the first clock 106a and the second clock 106b may have a frequency offset, the first clock counter and the second clock counter are often different at the same time point. For example, at a certain time point, the value of the first clock counter may be 20, and the value of the second clock counter may be 24.

In some embodiments, as shown in FIG. 2, for the first portion 101a, the first processor 102a, the first wireless communication module 103a, the first image acquisition module 104a and the first clock 106a are implemented on the same chip, also referred to as implemented as the same system on chip (hereinafter referred to as a first system on chip), while the first camera 105a is implemented as another independent chip (hereinafter referred to as a second chip). That is, the first camera 105a has an independent clock (timer). Even if the set capture and acquisition time is known, the frequency offset between independent clocks causes a timing difference between the first system on chip and the second chip to be uncontrollable to each other, which will further result in the inability to precisely synchronize the image capture and acquisition of the first camera 105a and the second camera 105b.

A system on chip is also called a SOC. For example, various RISC (Reduced Instruction Set Computer) processor IPs purchased from companies like ARM, etc. can be used as the processor of the SOC to perform corresponding functions, thereby enabling the implementation of an embedded system. Specifically, the modules (IP) available on the market have many modules, such as but not limited to memories, various communication modules (such as a Wi-Fi communication module and a Bluetooth communication module), image acquisition modules, buffers, and clocks. In some embodiments, chip manufacturers can also independently develop customized versions of these modules based on the off-the-shelf IP. In addition, other components such as antennas, sensor assemblies, speakers, and microphones can be connected externally to the IP. Users can build ASICs (Application-Specific Integrated Circuits) based on purchased IPs or self-developed modules to implement various communication modules, image acquisition modules, etc., thereby reducing power consumption and costs. For example, users can also use FPGAs (Field-Programmable Gate Arrays) to implement various communication modules, image acquisition modules, etc., which can be used to verify the stability of hardware design.

The first image acquisition module 104a is configured to transmit a first hardware trigger signal S1 based on the first clock 106a to the first camera 105a so as to trigger the first camera 105a to capture a first image, and acquire the first image. The second image acquisition module 104b is configured to transmit a second hardware trigger signal S2 based on the second clock 106b to the second camera 105b so as to trigger the second camera 105b to capture a second image, and acquire the second image. By triggering the capture of the first camera 105a with the first hardware trigger signal S1 and triggering the capture of the second camera 105b with the second hardware trigger signal S2 respectively, image acquisition can be initiated simultaneously as long as the first hardware trigger signal S1 and the second hardware trigger signal S2 are simultaneously output from the first image acquisition module 104a and the second image acquisition module 104b side, without considering the frequency offset of the clocks on the independent chips where the first camera 105a and the second camera 105b are located.

At least one of the first processor 102a and the second processor 102b is configured to, during the continuous use of the first image acquisition module 104a and the second image acquisition module 104b, enable the first wireless communication module 103a and the second wireless communication module 103b to perform wireless communication with each other (as shown in a communication signal S3) and/or wireless communication between both of them and a smart device (as shown in a communication signal S4), and determine a clock difference between the first wireless communication module 103a and the second wireless communication module 103b in performing the wireless communication respectively. The dynamic clock difference can be used to achieve the synchronization between the first hardware trigger signal S1 and the second hardware trigger signal S2. The so-called “clock difference” may be implemented as time2−time1 or time4−time3, and reference may be made to the detailed description in the following embodiments.

Specifically, at least one of the first processor 102a and the second processor 102b may be configured to, during the continuous use of the first image acquisition module 104a and the second image acquisition module 104b, enable one party of the first wireless communication module 103a and the second wireless communication module 103b to transmit a wireless signal S3 to the other party. The difference time2−time1 between the value time1 of a clock timer at a first time point when the one party transmits the wireless signal S3 and the value time2 of the clock counter at a second time point when the other party receives the wireless signal S3 can be determined. The air time for the transmission and reception of the wireless signal S3 between the two parties is usually negligible, so that the value difference time2−time1 is caused by the differences between the initial values and initial count time points of the first clock timer and the second clock timer, as well as the frequency offset between the first clock 106a and the second clock 106b. When the first clock 106a and the second clock 106b are synchronized, time2−time1 will be the same fixed value or an approximately fixed value. In some embodiments, the difference value of time2−time1 may be used to adjust the second clock 106b so that the first clock 106a and the second clock 106b are synchronized, thereby keeping time2−time1 at the same fixed value or an approximately fixed value.

In some embodiments, at least one of the first processor 102a and the second processor 102b is configured to, during the continuous use of the first image acquisition module 104a and the second image acquisition module 104b, enable the first wireless communication module 103a and the second wireless communication module 103b to each receive a wireless signal S4 from a smart device; and determine a value time3 of the clock timer at a third time point when the first wireless communication module 103a receives the wireless signal S4 and a value time4 of the clock counter at a fourth time point when the second wireless communication module 103b receives the wireless signal S4. The air time deviation of the wireless signal S4 received by the two party from the smart device is usually negligible, so that the value difference time4−time3 is also caused by the difference between the initial values and initial count time points of the first clock timer and the second clock timer, as well as the frequency offset between the first clock 106a and the second clock 106b. In some embodiments, the first wireless communication module 103a can be used to receive the wireless signal S4 from the smart device to achieve the synchronization between the first clock 106a and the wireless clock of the smart device, and the first wireless communication module 103b can be used to receive the wireless signal S4 from the smart device to achieve the synchronization between the second clock 106b and the wireless clock of the smart device, thereby achieving time synchronization between the first clock 106a and the second clock 106b, and also keeping time3−time4 at the same fixed value or an approximately fixed value.

At least one of the first processor 102a and the second processor 102b may achieve the synchronization between the first hardware trigger signal S1 and the second hardware trigger signal S2 by using the value difference. Specifically, the value difference (the value difference of time4−time3 or time2−time1 that can vary dynamically) can be considered and compensated when the first hardware trigger signal S1 and the second hardware trigger signal S2 are transmitted respectively, enabling dynamic and precise synchronization between the first hardware trigger signal S1 and the second hardware trigger signal S2.

Further, the value difference may also be used to achieve precise synchronization of wireless transceiver clocks between the first portion 101a and the second portion 101b. The first wireless communication module 103a and the second wireless communication module 103b may adopt various wireless communication modes, such as but not limited to Bluetooth modules, Wi-Fi modules, and UWB modules. For example, for the Bluetooth modules, a Bluetooth clock of the Bluetooth module of the first portion 101a can be synchronized with a Bluetooth clock of the Bluetooth module of the second portion 101b through relevant processing of Bluetooth access code or part of the access code of the physical layer. The Bluetooth clock is a wireless transceiver clock in a Bluetooth mode. For example, for the Wi-Fi modules, a Wi-Fi device will receive a beacon transmitted by an access device at the same time point (e.g., every 50 ms, 102.4 ms, 500 ms, etc.) according to a Wi-Fi protocol, and the Wi-Fi device may use the time of receiving the beacon as a Wi-Fi clock, that is, a wireless transceiver clock in a Wi-Fi mode. In the above examples, the wireless transceiver clock of the first portion 101a can be used as the first clock 106a, and the wireless transceiver clock of the second portion 101b can be used as the second clock 106b.

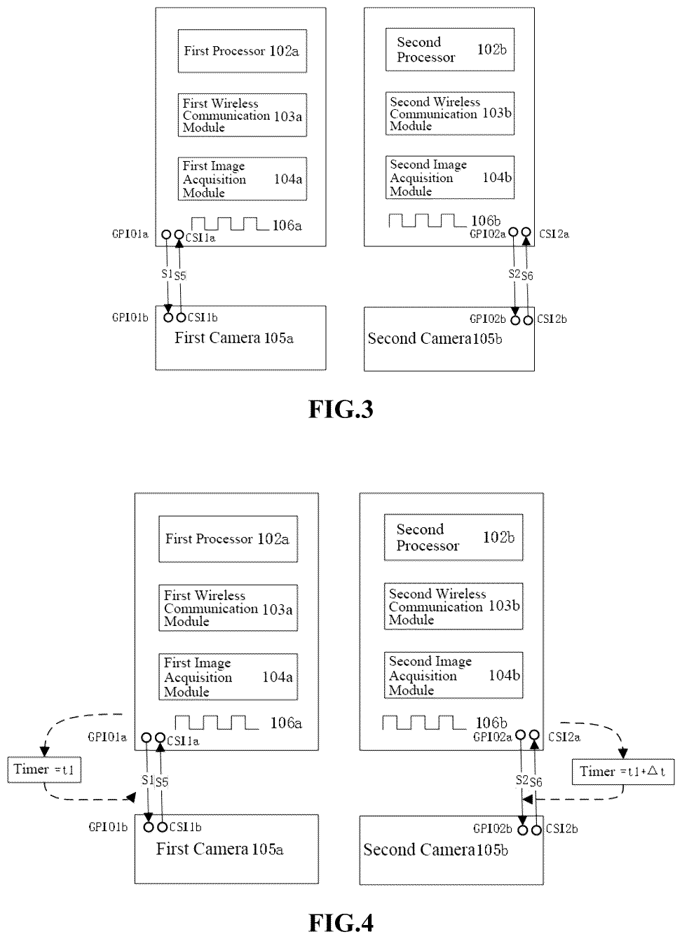

FIG. 3 illustrates a schematic diagram of a synchronization control method for image capture and acquisition of different cameras in a wireless smart wearable device according to a third embodiment of the present application. As shown in FIG. 3, the first image acquisition module 104a and the first camera 105a are connected via first (pair of) CSI interfaces CSI1a-CSI1b and first (pair of) GPIO interfaces GPIO1a-GPIO1b, and the second image acquisition module 104b and the second camera 105b are connected via second (pair of) CSI interfaces CSI2a-CSI2b and second (pair of) GPIO interfaces GPIO2a-GPIO2b.

Specifically, the first image acquisition module 104a is further configured to be connected to the first camera 105a via the first GPIO interfaces GPIO1a-GPIO1b so as to transmit the first hardware trigger signal S1 to the first camera 105a. The first camera 105a is further configured to, in response to receiving the first hardware trigger signal S1, initiate exposure and image capture and transmit an image S5 to the first image acquisition module 104a via the first CSI interfaces CSI1a-CSI1b.

The second image acquisition module 104b is further configured to be connected to the second camera 105b via the second GPIO interfaces GPIO2a-GPIO2b so as to transmit the second hardware trigger signal S2 to the second camera 105b. The second camera 105b is further configured to, in response to receiving the second hardware trigger signal S2, initiate exposure and image capture and transmit an image S6 to the second image acquisition module 104b via the second CSI interfaces CSI2a-CSI2b.

CSI, also referred to as Camera Serial Interface, is an interface typically equipped on the chip where the camera is located for exchanging image information with external devices, and is also an interface between a camera and a main processor. GPIO is also known as General-Purpose Input/Output, and a chip is usually equipped with a plurality of such pins. Thus, the various image acquisition modules and cameras can be connected through the CSI interfaces and the GPIO interfaces. By allowing the GPIO interfaces to be independently responsible for the transmission of the first hardware trigger signal S1 or the second hardware trigger signal S2, and allowing the CSI interfaces to be independently responsible for the transmission of images/videos, hardware paths independent of each other are provided for the transmission of the hardware trigger signals and image/video information, thereby ensuring the transmission speed and avoiding information interference with each other.

As for the wireless smart glasses device shown in FIG. 1, the left and right eyeglass portions 101a and 101b can simultaneously output the hardware trigger signals S1 and S2 to the first camera 105a and the second camera 105b through GPIO interface by the first image acquisition module 104a and the second image acquisition module 104b, respectively, thereby starting image acquisition at the same time. In each frame or every N (N is an integer greater than 1) frames (timed by their respective clocks, for example, whenever the value of the clock counter corresponding to each frame or every N frames is reached), the first image acquisition module 104a and the second image acquisition module 104b simultaneously output the hardware trigger signals S1 and S2 to the first camera 105a and the second camera 105b, respectively, so as to correct the asynchrony of the subsequently acquired left and right eyeglasses images caused by the frequency offset of pixel clocks of the left and right eyeglasses. After initiating acquisition, the first camera 105a and the second camera 105b transmit video images S5 and S6 to the first image acquisition module 104a and the second image acquisition module 104b, respectively, based on the configuration of parameters such as exposure time, exposure line count, line length, and frame length, and enable the left and right eyeglass portions 101a and 101b to acquire each frame of the image with the same nominal pixel clock count.

It is noted that in the present application, the so-called triggering of the capture (exposure) of the corresponding camera and the return of video images (image acquisition) by transmitting a hardware trigger signal means that the capture and return behaviors are triggered because of the reception of the hardware trigger signals (there is a causal relationship), but the capture and return time may be different from the reception time of the hardware trigger signals (not necessarily at the same time), at least after the reception time. In some embodiments, taking the first camera 105a as an example, exposure can be initiated after a predetermined time delay upon the first camera 105a receiving the first hardware trigger signal S1. The predetermined time delay is greater than the time offset caused by the frequency offset over the above interval of N frames, so as to ensure that the first camera 105a has not yet initiated exposure when receiving the first hardware trigger signal S1 after the interval of N frames. This prevents the first camera 105a from receiving the first hardware trigger signal S1 during the exposure, thereby avoiding frame loss or image errors in that frame.

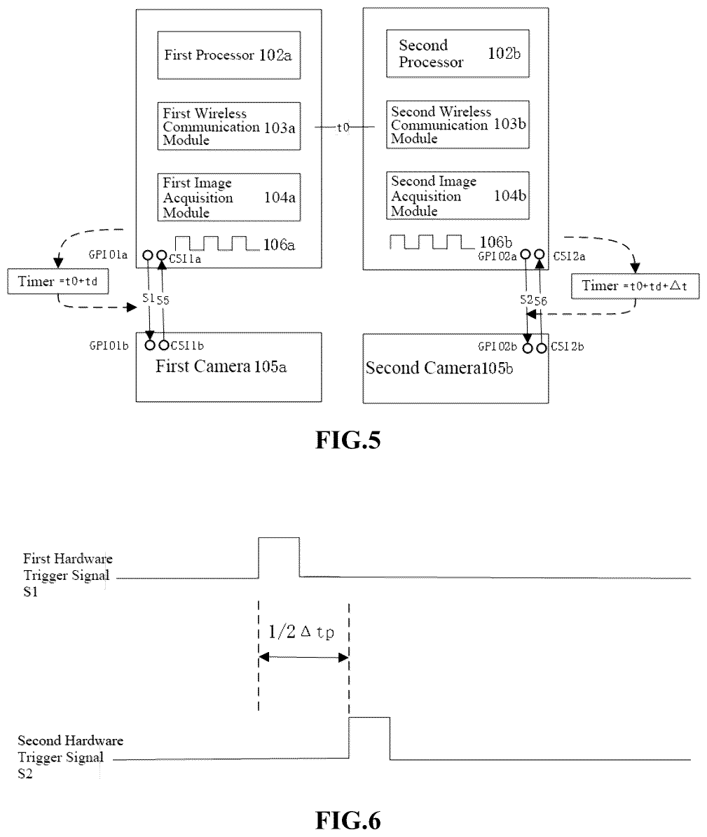

FIG. 4 illustrates a schematic diagram of a synchronization control method for image capture and acquisition of different cameras in a wireless smart wearable device according to a fourth embodiment of the present application. FIG. 5 illustrates a schematic diagram of a synchronization control method for image capture and acquisition of different cameras in a wireless smart wearable device Hereinafter, the synchronization control methods for image capture and acquisition of the respective different cameras will be described in detail in conjunction with FIG. 4 and FIG. 5, respectively.

As shown in FIG. 4, the first processor 102a may be further configured to generate the first hardware trigger signal S1 when the value of the clock counter of the first portion 101a is a first predetermined value t1. The second processor 102b is further configured to generate the second hardware trigger signal S2 when the value of the clock counter of the second portion 101b is a second predetermined value t1+Δt. The difference Δt between the first predetermined value t1 and the second predetermined value t1+Δt is set based on the above value difference time4−time3 or time2−time1, so that the first predetermined value t1 and the second predetermined value t1+Δt represent substantially the same time point for the clock timer of the first clock 106a and the clock timer of the second clock 106b, respectively. As an example, the difference Δt may be set to time4−time3 or time2−time1, and be updated as time4−time3 or time2−time1 changes dynamically. Thus, the first hardware trigger signal S1 and the second hardware trigger signal S2 can be generated substantially at the same time point, thereby achieving synchronous triggering of image capture and acquisition of the first camera 105a and the second camera 105b.

As shown in FIG. 5, the first processor 102a may be further configured to generate a reference hardware trigger signal (not shown) and acquire a reference value t0 of the clock counter of the first portion 101a at a trigger time point; enable the first wireless communication module 103a to transmit the reference value t0 to the second wireless communication module 103b; and generate the first hardware trigger signal S1 after a predetermined time delay td following the trigger time point t0. Correspondingly, the second processor 102b is further configured to determine, based on the reference value t0, the predetermined time delay td and the value difference Δt of the clock counter (e.g., time4−time3 or time2−time1), the value of the clock counter used to generate the second hardware trigger signal S2, e.g., t0+td+Δt; and generate the second hardware trigger signal S2 when the value of the clock counter of the second portion 101b reaches a determined value (e.g., t0+td+Δt), so that the first hardware trigger signal S1 and the second hardware trigger signal S2 are generated substantially at the same time point, thereby achieving synchronous triggering of image capture and acquisition of the first camera 105a and the second camera 105b. In some embodiments, the predetermined time delay td may be greater than the time offset caused by the frequency offset over the above interval of N frames, so as to ensure that the first camera 105a (the second camera 105b) has not yet initiated exposure when receiving the first hardware trigger signal S1 (the second hardware trigger signal S2) after the interval of N frames. This prevents the first camera 105a (the second camera 105b) from receiving the first hardware trigger signal S1 (the second hardware trigger signal S2) during the exposure, thereby avoiding frame loss or image errors in that frame. Meanwhile, the predetermined time delay td may also be used for the first wireless communication module 103a to transmit the reference value t0 or t0+td to the second wireless communication module 103b.

Returning to FIG. 1, in some embodiments, the first portion 101a and the second portion 101b each include a brightness detection unit 107a and a brightness detection unit 107b, which are configured to detect the brightness of ambient light of the corresponding first camera 105a and second camera 105b. In terms of wireless smart glasses, the difference between angles of the lenses relative to the ambient light source will result in different amounts of incident light during exposure and capture of the first camera 105a and the second camera 105b. At least one of the first processor 102a and the second processor 102b is further configured to set exposure times for the first camera 105a and the second camera 105b based on the brightness detected by the first portion 101a and the second portion 101b respectively, so that the lower the detected brightness corresponding to the camera, the longer its exposure time. That is, if the brightness of the ambient light of the first portion 101a detected by the brightness detection unit 107a is lower, the exposure time of the first camera 105a will be made longer to compensate for the insufficient brightness, so that the images/videos exposed and captured by the first camera 105a and the images/videos exposed and captured by the second camera 105b have consistent brightness, thereby contributing to improving the quality of the subsequent synthesized (fused) images.

In some embodiments, at least one of the first processor 102a and the second processor 102b may be further configured to, for the first camera 105a or the second camera 105b, for which a longer exposure time is required to be set, enable the first image acquisition module 104a or the second image acquisition module 104b connected thereto to generate and transmit the corresponding hardware trigger signal S1 or S2 a predetermined time in advance of the image acquisition module connected to the other camera. For ease of explanation, assuming that the excess amount of exposure time of a certain camera compared to another camera is Δtp, the advanced predetermined time can be set according to the excess amount Δtp. The setting method can be adapted according to a set rule of a time point to which the images acquired during the entire exposure period belong. For example, the acquired image may be used as an image at an intermediate time point in the exposure period in a case where the exposure period lasts relatively long. Accordingly, in a case where the excess amount of the exposure time of the first camera 105a compared to that of the second camera 105b is Δtp, as shown in FIG. 6, the timing of the first hardware trigger signal S1 is earlier than that of the second hardware trigger signal S2 by approximately half of the excess amount of the exposure time, that is, approximately ½ Δtp. In this way, it can not only compensates for insufficient brightness of the first camera 105a, but also keep the images acquired by the first camera 105a and the second camera 105b during their respective exposure periods of each other remain synchronized without being affected by the relatively long duration of the exposure periods.

Benefiting from dynamic and precise synchronization between the first image and the second image, the first image and the second image can be used for fusion to meet various ever-increasing needs of users. For example, at least one of the first processor 102a and the second processor 102b may be further configured to generate a panoramic video or perform simultaneous localization and mapping by using the first image and the second image.

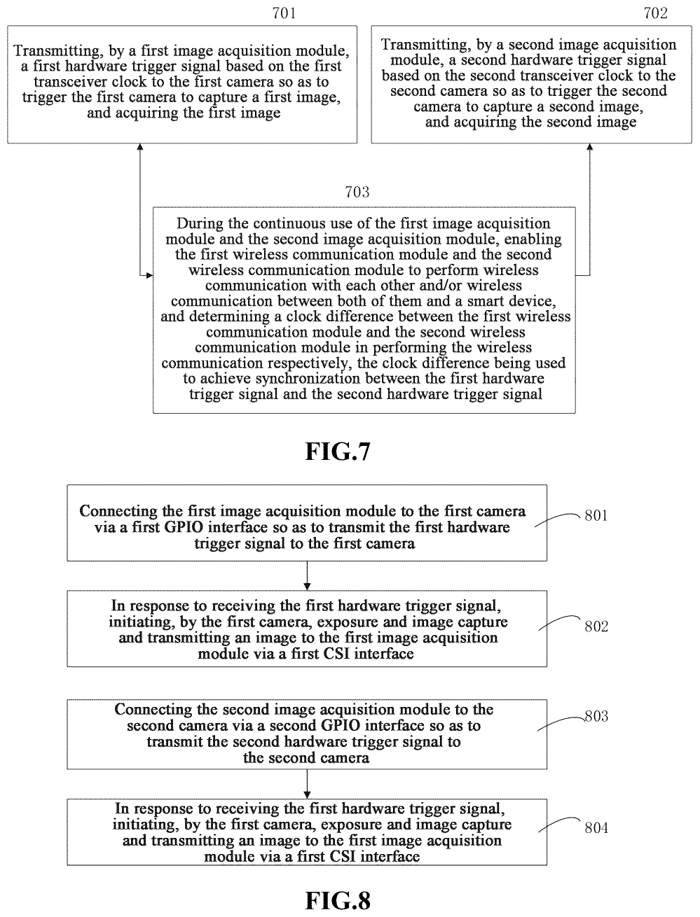

FIG. 7 illustrates a flowchart of an image acquisition method for a wireless smart wearable device according to a seventh embodiment of the present application. The wireless smart wearable device may, for example, adopt the configuration as shown in FIGS. 1 and 2, but is not limited thereto, and includes a first portion and a second portion that can communicate with each other wirelessly. The first portion includes a first processor, a first wireless communication module, a first camera, and a first image acquisition module, and has a first clock. The second portion includes a second processor, a second wireless communication module, a second camera, and a second image acquisition module, and has a second clock. Wherein the first clock and the second clock are independent of each other and may have a frequency offset. Various cameras may be provided on an independent chip or on the same system on chip with other components, which is not limited here.

As shown in FIG. 7, the image acquisition method may include the following steps.

In step 701, during the continuous use of the first image acquisition module and the second image acquisition module, the first wireless communication module and the second wireless communication module are enabled to perform wireless communication with each other and/or wireless communication between both of them and a smart device, and a clock difference between the first wireless communication module and the second wireless communication module in performing the wireless communication respectively is determined.

In step 702, the first image acquisition module may transmit a first hardware trigger signal based on the first clock to the first camera so as to trigger the first camera to capture a first image, and acquire the first image.

In step 703, the second image acquisition module 104b transmits a second hardware trigger signal based on the second clock 106b to the second camera 105b so as to trigger the second camera 105b to capture a second image, and acquires the second image.

It is noted that step 702 and step 703 are parallel processing steps controlled by the first image acquisition module and the second image acquisition module side, respectively.

The first hardware trigger signal and the second hardware trigger signal are synchronized using the dynamic clock difference (that is, the value difference between the clock counters at transmitting and receiving timing) determined in step 701, for example but not limited to compensating for the value difference between the values of the clock counters corresponding to the first hardware trigger signal and the second hardware trigger signal, so that the first hardware trigger signal and the second hardware trigger signal are transmitted at substantially the same time. In this way, no matter how the frequency offset of the first clock and the second clock changes dynamically, it can be dynamically captured and timely and precisely compensated, thereby initiating the image capture and acquisition of the first camera and the second camera simultaneously, without needing to consider the frequency offset of the clocks on the respective independent chips of the first portion and the second portion where the first camera and the second camera are located. The captured and acquired first image and second image may keep precise dynamic synchronization and may be used for fusion to meet various ever-increasing needs of users. For example, they may be used for generating a panoramic video or simultaneous localization and mapping.

FIG. 8 illustrates a flowchart of an image acquisition method for a wireless smart wearable device according to an eighth embodiment of the present application. In step 801, the first image acquisition module is connected to the first camera via a first GPIO interface so as to transmit the first hardware trigger signal to the first camera. In step 802, the first camera initiates exposure and image capture in response to receiving the first hardware trigger signal, and transmits an image to the first image acquisition module via the first CSI interface.

In step 803, the second image acquisition module is connected to the second camera via a second GPIO interface so as to transmit the second hardware trigger signal to the second camera. In step 804, in response to receiving the second hardware trigger signal, the second camera initiates exposure and image capture and transmits an image to the second image acquisition module via a second CSI interface. Thus, the various image acquisition modules and cameras can be connected through the CSI interfaces and the GPIO interfaces. By allowing the GPIO interfaces to independently be responsible for the transmission of the first hardware trigger signal or the second hardware trigger signal, and allowing the CSI interfaces to independently be responsible for the transmission of images/videos, hardware paths independent of each other are provided for the transmission of the hardware trigger signals and image/video information, thereby ensuring the transmission speed and avoiding information interference with each other.

In some embodiments, the clock difference between the first wireless communication module and the second wireless communication module in performing the wireless communication respectively may be determined through the following steps. During the continuous use of the first image acquisition module and the second image acquisition module, one party of the first wireless communication module and the second wireless communication module is enabled to transmit a wireless signal to the other party; and a value difference between clock counters at a first time point when the one party transmits the wireless signal and at a second time point when the other party receives the wireless signal is determined as the clock difference. The wireless signal includes a signal sequence known to a receiver, for example, for a Bluetooth module, the signal sequence may be a Bluetooth access code of the physical layer, and for a Wi-Fi module, it may be a beacon signal.

In some embodiments, the clock difference between the first wireless communication module and the second wireless communication module in performing the wireless communication respectively may be determined through the following steps. During the continuous use of the first image acquisition module and the second image acquisition module, the first wireless communication module and the second wireless communication module are enabled to each receive a wireless signal from a smart device; and a value difference between the clock counters at a third time point when the first wireless communication module receives the wireless signal and at a fourth time point when the second wireless communication module receives the wireless signal is determined as the clock difference. The wireless signal includes a signal sequence known to a receiver, for example, for a Bluetooth module, the signal sequence may be a Bluetooth access code of the physical layer, and for a Wi-Fi module, it may be a beacon signal.

The mutual communication between the first portion and the second portion, and the joint communication between the first portion/the second portion and the smart device are regular communications and occur continuously for wireless smart wearable devices such as smart glasses, so that the user experience will not be affected while the clock difference is dynamically determined.

Various methods can be employed to achieve timing synchronization between the first and second hardware trigger signals.

For example, the first hardware trigger signal may be generated when the value of the clock counter of the first portion is a first predetermined value; and the second hardware trigger signal may be generated when the value of the clock counter of the second portion is a second predetermined value, wherein the difference between the first predetermined value and the second predetermined value is set based on the value difference, thereby characterizing the same time point.

For another example, a reference hardware trigger signal may be generated at the first portion, and a reference value of the clock counter of the first portion at a trigger time point is acquired; the reference value is transmitted to the second wireless communication module via the first wireless communication module; the first hardware trigger signal is generated after a predetermined time delay subsequent to the trigger time point; the value of the clock counter used to generate the second hardware trigger signal is determined at the second portion based on the reference value, the predetermined time delay and the value difference of the clock counter; and the second hardware trigger signal is generated when the value of the clock counter of the second portion reaches a determined value, so that the first hardware trigger signal and the second hardware trigger signal are generated at the same time point.

The above timing synchronization control methods have been described in detail above in conjunction with FIGS. 4 and 5, and will not be elaborated here.

In some embodiments, the image acquisition method may further include detecting and compensatively balancing the brightness of ambient light for each camera. The brightness of ambient light of the first camera and the second camera can be detected; and exposure times for the first camera and the second camera are set, such that the lower the brightness of ambient light, the longer the exposure time of the corresponding camera.

In some embodiments, the image acquisition method may further include: for the first camera or the second camera, for which a longer exposure time is required to be set, enabling the image acquisition module connected thereto to generate and transmit the corresponding hardware trigger signal a predetermined time in advance of the image acquisition module connected to the other camera. As an example, the advanced predetermined time is approximately half of an excess amount of the exposure time.

The detection and compensative balance of the brightness of ambient light of each camera has been described in detail above in conjunction with FIG. 6, and will not be elaborated here.

The following describes a variation example of the wireless smart wearable device. The wireless smart wearable device of this variant example can adopt the hardware configuration shown in FIG. 10. The first clock 106a and the second clock 106b are independent of each other and also contain the function of a clock counter, and for the sake of simplicity of description, are referred to as the first clock counter 106a and the second clock counter 106b below, respectively. The difference from the hardware configuration shown in FIG. 2 lies in that this variation example does not rely on the GPIO interfaces and does not need to transmit a hardware trigger signal from the chip on the image acquisition module side to the chip on the camera side, but instead, uses each frame of images captured by a certain camera as a reference image, takes into account the clock difference in the timing of capturing and acquiring the corresponding frames (such as adjacent frames) between another camera and it, and performs interpolation by taking the capture and acquisition timing of the reference image as a standard, so as to obtain synchronized images. For the structural portions in FIG. 10 that are the same as those in FIG. 2, reference is made to the above description and will not be elaborated here, and only the difference between the two will be explained.

In the following, a wireless smart glasses device is used as an example of the wireless smart wearable device for explanation, and the first image captured by the first camera 105a of the first portion 101a is used as the reference image for illustration. However, it should be noted that the wireless smart wearable device may adopt other configurations, the first portion 101a and the second portion 101b can be switched between the left eyeglass portion and the right eyeglass portion, and the first image captured and acquired by the first camera 105a and the second image captured and acquired by the second camera 105b can be switched and used as the reference image.

Specifically, the first image acquisition module 104a is configured to interconnect with the first camera 105a via first CSI interfaces CSI1a-CSI1b, and acquire each frame of a first image S5 captured by the first camera 105a as a reference image. The second image acquisition module 104b is configured to interconnect with the second camera 105b via second CSI interfaces CSI2a-CSI2b, and acquire each frame of a second image S6 captured by the second camera 105b.

The first processor 102a is configured to acquire a first value of the first clock counter 106a when the first image acquisition module 104a receives a SOT or EOT signal for transmitting each frame of the first image from the first CSI interface, or after a preset time delay thereafter. The second processor 102b is configured to acquire a second value of the second clock counter 106b when the second image acquisition module 104b receives a SOT or EOT signal for transmitting each frame of the second image from the second CSI interface, or after the preset time delay thereafter.

In some embodiments, the first value of the first clock counter 106a and the second value of the second clock counter 106b can be compensated and adjusted based on the difference between count values of the first clock counter 106a and the second clock counter 106b at the same time point, and then are subsequently analyzed. That is, the value of the first clock counter 106a (for example but not limited to the first value) and the corresponding value of the second clock counter 106b (for example but not limited to the second value), which are used for interpolation processing below can be compensated and adjusted using the value difference between the first clock counter 106a and the second clock counter 106b at the same time point, so as to eliminate the value difference at the same actual time point caused by, for example, the starting count value and/or frequency offset of the two clock counters. The value difference may be, for example, time2−time1, or time4−time3, as described in detail in the following embodiments.

Specifically, referring to FIG. 10, at least one of the first processor 102a and the second processor 102b may be configured to, during the continuous use of the first image acquisition module 104a and the second image acquisition module 104b, enable one party of the first wireless communication module 103a and the second wireless communication module 103b to transmit a wireless signal S3 to the other party (referring back to FIG. 2). A difference time2−time1 between a value time1 of the clock counter at a first time point when the one party transmits the wireless signal S3 and a value time2 of the clock counter at a second time point when the other party receives the wireless signal S3 can be determined. An air time for transmitting and receiving the wireless signal S3 between the two parties is usually negligible, thus the value difference time2−time1 is caused by the difference between the initial values and initial count time points of the first clock timer and the second clock timer, as well as the frequency offset between the first clock 106a and the second clock 106b. Upon the first clock 106a and the second clock 106b being synchronized, time2−time1 will be the same fixed value or an approximately fixed value. In some embodiments, the difference value of time2−time1 may be used to adjust the second clock 106b so that the first clock 106a and the second clock 106b are synchronized, thereby keeping time2−time1 at the same fixed value or an approximately fixed value.

In some embodiments, at least one of the first processor 102a and the second processor 102b is configured to, during the continuous use of the first image acquisition module 104a and the second image acquisition module 104b, enable the first wireless communication module 103a and the second wireless communication module 103b to each receive a wireless signal S4 from a smart device (referring back to FIG. 2); and determine a value time3 of the clock timer at a third time point when the first wireless communication module 103a receives the wireless signal S4 and a value time4 of the clock counter at a fourth time point when the second wireless communication module 103b receives the wireless signal S4. The air time deviation of the wireless signal S4 received by the two from the smart device is usually negligible, so that the value difference time4−time3 is also caused by the difference between the initial values and initial count time points of the first clock timer and the second clock timer, as well as the frequency offset between the first clock 106a and the second clock 106b. In some embodiments, the first wireless communication module 103a can be used to receive the wireless signal S4 from the smart device to achieve synchronization between the first clock 106a and the wireless clock of the smart device, and the first wireless communication module 103b can be used to receive the wireless signal S4 from the smart device to achieve synchronization between the second clock 106b and the wireless clock of the smart device, thereby achieving time synchronization between the first clock 106a and the second clock 106b, and also keeping time3−time4 at the same fixed value or an approximately fixed value.

A compensation adjustment may be performed based on the count values of the first clock counter 106a and the second clock counter 106b by utilizing the value difference time2−time1 or time4−time3. Specifically, if time2 is the value of the clock counter at the first time point when the second wireless communication module 103b transmits the wireless signal S3, time1 is the value of the clock counter at the second time point when the first wireless communication module 103a receives the wireless signal S3, and time2>time1, the dynamic count value of the second clock counter 106b can be subtracted by (time2−time1), thereby eliminating the adverse effects of the differences between the initial values and initial count time points of the first clock timer and the second clock timer, as well as the frequency offset between the first clock 106a and the second clock 106b. For another example, if time4>time3, the dynamic count value of the second clock counter 106b can be subtracted by (time4−time3), thereby eliminating the adverse effects of the differences between the initial values and initial count time points of the first clock timer and the second clock timer, as well as the frequency offset between the first clock 106a and the second clock 106b.

After the compensation adjustment of the count values, an actual time sequence between the time when a SOT or EOT signal for transmitting each frame of the first image is received from the first CSI interface or after a preset time delay thereafter and the time when a SOT or EOT signal for transmitting each frame of the second image is received from the second CSI interface or after the preset time delay thereafter can be obtained after the adverse effects of the differences between the initial values and initial count time points of the first clock timer and the second clock timer, as well as the frequency offset between the first clock 106a and the second clock 106b are eliminated, so as to facilitate better synchronization between the image after subsequent interpolation processing and the reference image.

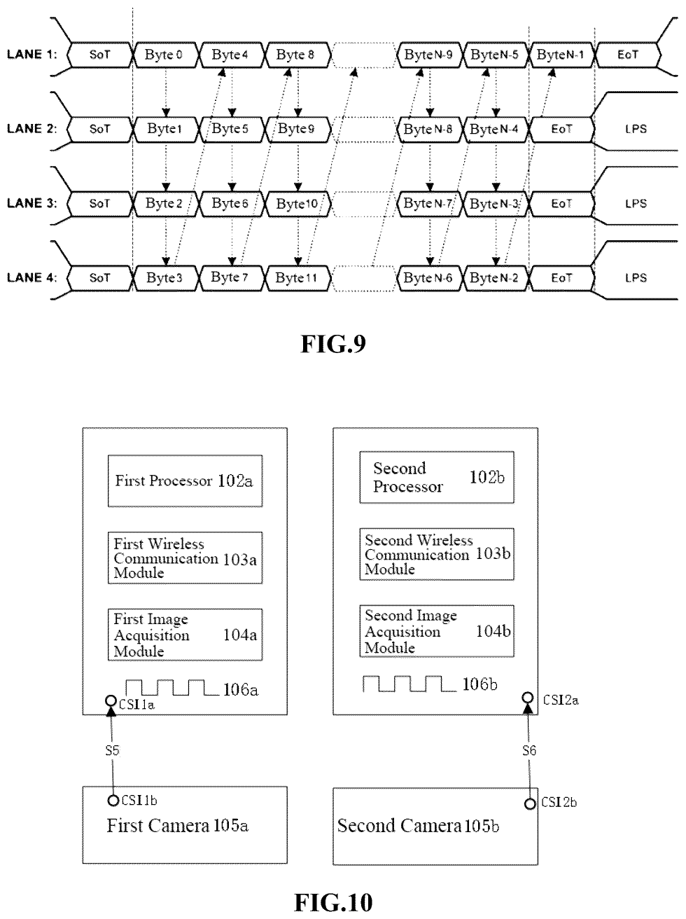

As shown in FIG. 9, a timing diagram of a CSI interface connection defined according to the MIPI CSI-2 protocol when transmitting a data packet is shown. The CSI interface is for unidirectional transmission, transmitting outward from the cameras, and it includes one clock lane (data channel) and one to four data lanes. The four data lanes are LANE 1, LANE 2, LANE 3, and LANE 4 as shown in FIG. 9.

SOT, also known as a transmission start signal, and EOT, also known as a transmission end signal, are transmission timing reference signals when the CSI interface transmits image information from the cameras. Therefore, the first value and the second value essentially represent the respective capture and acquisition times of the first image and the second image. As shown in FIG. 9, on each LANE, a payload (byte 0-byte N−1, where N is a positive integer) is transmitted between the SOT signal and EOT signal. There is an LPS state (low power state) between individual data packets.

The first processor 102a or the second processor 102b is further configured to enable the first wireless communication module 103a to transmit the first value to the second wireless communication module 103b, or to enable the first wireless communication module 103a and the second wireless communication module 103b to transmit the first value, the second value and the second image to the smart device, so that the second processor 102b or a third processor 102c (see FIG. 2) in the smart device acquires the first value, the second value along with the second image. Further, the second processor 102b or the third processor 102c in the smart device, which has acquired the first value, the second value along with the second image is further configured to perform, based on the first value and the second value that are compensated and adjusted using the value difference between the first clock counter 106a and the second clock counter 106b at the same time point, interpolation processing on each frame of the second image to obtain each frame of a third image which is synchronized with each frame of the first image. Therefore, by utilizing the conventional signal interaction mode of the CSI interface and through simple interpolation operations, precise and dynamic synchronization between each frame of images of the first portion 101a and the second portion 101b can be conveniently achieved without the need for interactive configuration of other hardware interfaces. This level of precise and dynamic synchronization enables each frame of the first image and each frame of the synchronized third image to be used for generating a panoramic video or performing simultaneous localization and mapping.

Before the interpolation operation, the clock difference between the first clock 106a and the second clock 106b may be considered first as in other embodiments described above, and the first value and/or the second value may be compensated and adjusted accordingly and then used for interpolation processing on each frame of the second image. The method for compensating and adjusting the first value and/or the second value by using the value difference between the first clock counter 106a and the second clock counter 106b at the same time point described in various embodiments of the present application can be combined here. The value difference may be, for example, time2−time1, or time4−time3, as described in detail in various embodiments.

For example, at least one of the first processor 102a and the second processor 102b is further configured to, during the continuous use of the first image acquisition module 104a and the second image acquisition module 104b, enable the first wireless communication module 103a and the second wireless communication module 103b to perform wireless communication with each other and/or wireless communication between both of them and a smart device; calculate a value difference between the first clock counter 106a and the second clock counter 106b when the first wireless communication module 103a and the second wireless communication module 103b are used to perform the wireless communication; and compensate and adjust the first value and/or the second value based on the value difference, and then use the two for performing interpolation processing on each frame of the second image. The above has described in detail how to use the first wireless communication module 103a and the second wireless communication module 103b to perform wireless communication with each other and/or wireless communication between both of them and the smart device to determine the clock difference (i.e., the value difference between the first clock counter 106a and the second clock counter 106b), and how to use the value difference to perform compensation adjustment. These descriptions are incorporated herein and will not be elaborated here.

In some embodiments, the second processor 102b is further configured to acquire two corresponding second values T0 and T2 of the second clock counter 106b when the second image acquisition module 104b receives the SOT or EOT signal for transmitting the (N−1)th frame and the Nth frame of the second images from the second CSI interfaces CSI2a-CSI2b, or after the preset time delay thereafter. The second processor 102b can acquire the corresponding first value T1 of the first clock counter when the first image acquisition module 104a receives the SOT or EOT signal for transmitting the Nth frame of the first image from the first CSI interfaces CSI1a-CSI1b, or after the preset time delay thereafter, wherein T2 is greater than or equal to T1. That is, the first value T1 of the timing corresponding to the Nth frame of the first image may be between the two values T0 and T2 of the timing corresponding to the (N−1)th frame and the Nth frame of the second images.

The second processor 102b may acquire the (N−1)th frame of the second image and the Nth frame of the second image, and performs interpolation processing on the acquired (N−1)th frame of the second image and Nth frame of the second image according to the following formula (1) to obtain the Nth frame of the third image synchronized with the Nth frame of the first image:

$$New\_image = \qquad formula ( 1 )$$

$$[ image\_N \_ 1 * ( T 2 - T 1 ) + image\_N * ( T 1 - T 0 ) ] / ( T 2 - T 0 ) ,$$

Wherein New_image represents the Nth frame of the third image synchronized with the Nth frame of the first image, image_N_1 represents the (N−1)th frame of the second image, and image_N represents the Nth frame of the second image.

Referring back to FIG. 1, the first portion 101a and the second portion 101b each include a brightness detection unit 107a and a brightness detection unit 107b, which are configured to detect the brightness of ambient light of the corresponding first camera 105a and second camera 105b. At least one of the first processor 102a and the second processor 102b is further configured to set exposure times for the first camera 105a and the second camera 105b based on the brightness detected by the first portion 101a and the second portion 101b respectively, so that the lower the detected brightness corresponding to a camera, the longer its exposure time.

For the corresponding second value T2 of the second clock counter 106b when the second image acquisition module 104b receives the SOT or EOT signal for transmitting the Nth frame of the second image from the second CSI interfaces CSI2a-CSI2b, or after the preset time delay thereafter, it can be adjusted according to the difference between the exposure times of the first camera 105a and the second camera 105b.

Specifically, the second processor 102b may be further configured to acquire a first exposure time t00 of the first camera and a second exposure time t11 of the second camera; and calculate the adjusted second value T2′ of T2 according to the following formula (2):

$$T {2}^{′} = T 2 - ( t 11 - t 00 ) / 2. \qquad formula ( 2 )$$

In a case where the exposure period lasts relatively long, the acquired image can be taken as an image at an intermediate time point in the exposure period. For example, in a case where the excess amount of the exposure time of the second camera 105b compared to the first camera 105a is t11−t00, T2 is advanced by approximately half of the excess amount of the exposure time t11−t00/2. In this way, not only can the insufficient brightness of the second camera 105b be compensated, but also the images acquired by the first camera 105a and the second camera 105b during their respective exposure periods can be kept synchronized, without being affected by the relatively long duration of the exposure periods. The second value T2′ adjusted above can be substituted into T2 in formula (1) to perform interpolation to obtain the Nth frame of the third image synchronized with the Nth frame of the first image.

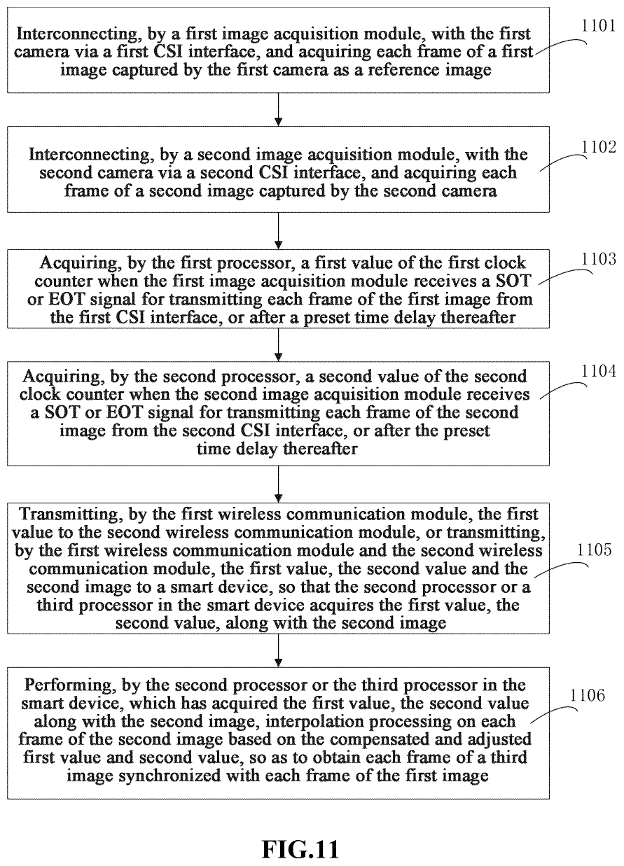

FIG. 11 illustrates a flowchart of an image acquisition method for a wireless smart wearable device according to an eleventh embodiment of the present application. The wireless smart wearable device includes a first portion and a second portion that communicates with each other wirelessly. The first portion includes a first processor, a first wireless communication module, a first camera, a first image acquisition module, and a first clock counter. The second portion includes a second processor, a second wireless communication module, a second camera, a second image acquisition module, and a second clock counter. The first clock counter and the second clock timer are independent of each other and may have a dynamic clock deviation therebetween. The wireless smart wearable device may adopt the structure according to various embodiments of the present application, as long as the process of the image acquisition method can be collaboratively implemented, which will not be elaborated here.

As shown in FIG. 11, the image acquisition method includes the following steps.

In step 1101, a first image acquisition module is interconnected with the first camera via a first CSI interface, and acquires each frame of a first image captured by the first camera as a reference image.

In step 1102, a second image acquisition module is interconnected with the second camera via a second CSI interface, and acquires each frame of a second image captured by the second camera.

In step 1103, the first processor acquires a first value of the first clock counter when the first image acquisition module receives a SOT or EOT signal for transmitting each frame of the first image from the first CSI interface, or after a preset time delay thereafter.

In step 1104, the second processor acquires a second value of the second clock counter when the second image acquisition module receives a SOT or EOT signal for transmitting each frame of the second image from the second CSI interface, or after the preset time delay thereafter.

In step 1105, the first wireless communication module transmits the first value to the second wireless communication module, or the first wireless communication module and the second wireless communication module transmit the first value, the second value and the second image to a smart device, so that the second processor or a third processor in the smart device acquires the first value, the second value, along with the second image.

In step 1106, the second processor or the third processor in the smart device, which has acquired the first value, the second value along with the second image, performs interpolation processing on each frame of the second image based on the first value and the second value, so as to obtain each frame of a third image synchronized with each frame of the first image.

The processing steps of the image acquisition method described in the aforementioned embodiments in conjunction with the structure of the wireless smart wearable device can all be incorporated herein and thus will not be elaborated here.

In some embodiments, the image acquisition method may also include: during the continuous use of the first image acquisition module and the second image acquisition module, performing, by the first wireless communication module and the second wireless communication module, wireless communication with each other and/or wireless communication between both of them and a smart device; calculating a value difference between the first clock counter and the second clock counter when the first wireless communication module and the second wireless communication module are used to perform the wireless communication; and compensating and adjusting the first value and/or the second value based on the value difference, and then using the two for performing interpolation processing on each frame of the second image.

In some embodiments, the image acquisition method further includes: generating a panoramic video or performing simultaneous localization and mapping by using each frame of the first image and each synchronized frame of the third image.

In some embodiments, the image acquisition method further includes, by the second processor: acquiring two corresponding second values TO and T2 of the second clock counter when the second image acquisition module receives the SOT or EOT signal for transmitting the (N−1)th frame and the Nth frame of the second images from the second CSI interface, or after the preset time delay thereafter; acquiring the first value T1 corresponding to the first clock counter when the first image acquisition module receives the SOT or EOT signal for transmitting the Nth frame of the first image from the first CSI interface, or after the preset time delay, wherein T2 is greater than or equal to T1; and acquiring the (N−1)th frame of the second image and the Nth frame of the second image, and performing interpolation processing on the acquired (N−1)th frame of the second image and the Nth frame of the second image according to the following formula (1) to obtain the Nth frame of the third image synchronized with the Nth frame of the first image:

$$New\_image = \qquad formula ( 1 )$$

$$[ image\_N \_ 1 * ( T 2 - T 1 ) + image\_N * ( T 1 - T 0 ) ] / ( T 2 - T 0 ) ,$$

Wherein New_image represents the Nth frame of the third image synchronized with the Nth frame of the first image, image_N_1 represents the (N−1)th frame of the second image, and image_N represents the Nth frame of the second image.

In some embodiments, the image acquisition method further includes: detecting the brightness of ambient light of the first camera and the second camera; and setting exposure times for the first camera and the second camera, so that the lower the brightness of ambient light, the longer the exposure time of the corresponding camera.

In some embodiments, the image acquisition method further includes, by the second processor: acquiring a first exposure time t00 of the first camera and a second exposure time t11 of the second camera; and calculating, according to the following formula (2), the adjusted corresponding second value T2′ of the second clock counter when the SOT or EOT signal of the second value from the second CSI interfaces for transmitting the Nth frame of the second image is received from the second CSI interfaces, or after the preset time delay thereafter:

$$T {2}^{′} = T 2 - ( t 11 - t 00 ) / 2. \qquad formula ( 2 )$$

The above adjusted second value T2′ can be substituted into T2 in formula (1) to perform interpolation to obtain the Nth frame of the third image synchronized with the Nth frame of the first image.

The various embodiments described above are merely examples and are not intended to limit the scope of protection of the present invention. The scope of protection of the present invention is defined by the claims. Those skilled in the art may make various variations and modifications to the various embodiments without departing from and exceeding the scope of protection of the claims. The combinations of the technical features described in the above embodiments are not limited to the combinations described in the respective embodiments, but the technical features in different embodiments can also be flexibly combined with each other. The technical solution defined by each claim constitutes an independent embodiment and can be combined with each other.

What is claimed is:

1. A wireless smart wearable device, comprising a first portion and a second portion that can communicate with each other wirelessly,
wherein the first portion comprises a first processor, a first wireless communication module, a first camera, and a first image acquisition module, and has a first clock, and the second portion comprises a second processor, a second wireless communication module, a second camera, and a second image acquisition module, and has a second clock;
the first image acquisition module is configured to transmit a first hardware trigger signal based on the first clock to the first camera so as to trigger the first camera to capture a first image, and acquire the first image;
the second image acquisition module is configured to transmit a second hardware trigger signal based on the second clock to the second camera so as to trigger the second camera to capture a second image, and acquire the second image; and
at least one of the first processor and the second processor is configured to, during continuous use of the first image acquisition module and the second image acquisition module, enable the first wireless communication module and the second wireless communication module to perform wireless communication with each other and/or wireless communication between both of them and a smart device, and determine a clock difference between the first wireless communication module and the second wireless communication module in performing the wireless communication respectively, the clock difference being used to achieve synchronization between the first hardware trigger signal and the second hardware trigger signal.

2. The wireless smart wearable device according to claim 1, wherein the wireless smart wearable device comprises a wireless smart glasses device, one of the first portion and the second portion is a left eyeglass portion and the other one is a right eyeglass portion.

3. The wireless smart wearable device according to claim 1, wherein
the first image acquisition module and the first camera are connected via a first CSI interface and a first GPIO interface, and the second image acquisition module and the second camera are connected via a second CSI interface and a second GPIO interface;
the first image acquisition module is further configured to be connected to the first camera via the first GPIO interface so as to transmit the first hardware trigger signal to the first camera;
the first camera is further configured to, in response to receiving the first hardware trigger signal, initiate exposure and image capture and transmit an image to the first image acquisition module via the first CSI interface;
the second image acquisition module is further configured to be connected to the second camera via the second GPIO interface so as to transmit the second hardware trigger signal to the second camera; and
the second camera is further configured to, in response to receiving the second hardware trigger signal, initiate exposure and image capture and transmit an image to the second image acquisition module via the second CSI interface.

4. The wireless smart wearable device according to claim 3, wherein at least one of the first processor and the second processor is configured to, during the continuous use of the first image acquisition module and the second image acquisition module, enable one party of the first wireless communication module and the second wireless communication module to transmit a wireless signal to the other party; and determine a value difference between clock counters at a first time point when the one party transmits the wireless signal and at a second time point when the other party receives the wireless signal, the value difference being used to achieve the synchronization between the first hardware trigger signal and the second hardware trigger signal.

5. The wireless smart wearable device according to claim 3, wherein at least one of the first processor and the second processor is configured to, during the continuous use of the first image acquisition module and the second image acquisition module, enable the first wireless communication module and the second wireless communication module to each receive the wireless signal from the smart device; and determine a value difference between the clock counters at a third time point when the first wireless communication module receives the wireless signal and at a fourth time point when the second wireless communication module receives the wireless signal, the value difference being used to achieve the synchronization between the first hardware trigger signal and the second hardware trigger signal.

6. The wireless smart wearable device according to claim 4, wherein
the first processor is further configured to generate the first hardware trigger signal when the value of the clock counter of the first portion is a first predetermined value;
the second processor is further configured to generate the second hardware trigger signal when the value of the clock counter of the second portion is a second predetermined value; and
the difference between the first predetermined value and the second predetermined value is set based on the value difference, thereby characterizing the same time point.

7. The wireless smart wearable device according to claim 4, wherein
the first processor is further configured to generate a reference hardware trigger signal and acquire a reference value of the clock counter of the first portion at a trigger time point; enable the first wireless communication module to transmit the reference value to the second wireless communication module; and generate the first hardware trigger signal after a predetermined time delay subsequent to the trigger time point; and
the second processor is further configured to determine, based on the reference value, the predetermined time delay and the value difference of the clock counter, the value of the clock counter used to generate the second hardware trigger signal; and generate the second hardware trigger signal when the value of the clock counter of the second portion reaches a determined value, so that the first hardware trigger signal and the second hardware trigger signal are generated at the same time point.

8. The wireless smart wearable device according to claim 3, wherein
the first portion and the second portion each comprises a brightness detection unit configured to detect the brightness of ambient light of the corresponding camera; and
at least one of the first processor and the second processor is further configured to set exposure times for the first camera and the second camera based on the brightness detected by the first portion and the second portion respectively, so that the lower the detected brightness corresponding to a camera, the longer its exposure time.

9. The wireless smart wearable device according to claim 8, wherein at least one of the first processor and the second processor is further configured to, for the first camera or the second camera, for which a longer exposure time is required to be set, enable the image acquisition module connected thereto to generate and transmit the corresponding hardware trigger signal a predetermined time in advance of the image acquisition module connected to the other camera.

10. The wireless smart wearable device according to claim 9, wherein the advanced predetermined time is approximately half of an excess amount of the exposure time.

11. The wireless smart wearable device according to claim 2, wherein at least one of the first processor and the second processor is further configured to generate a panoramic video or perform simultaneous localization and mapping by using the first image and the second image.

12. An image acquisition method for a wireless smart wearable device, the wireless smart wearable device comprising a first portion and a second portion that can communicate with each other wirelessly, wherein the first portion comprises a first processor, a first wireless communication module, a first camera, and a first image acquisition module, and has a first clock, and the second portion comprises a second processor, a second wireless communication module, a second camera, and a second image acquisition module, and has a second clock, the method comprising:
during continuous use of the first image acquisition module and the second image acquisition module, enabling the first wireless communication module and the second wireless communication module to perform wireless communication with each other and/or wireless communication between both of them and a smart device, and determining a clock difference between the first wireless communication module and the second wireless communication module in performing the wireless communication respectively;
transmitting, by the first image acquisition module, a first hardware trigger signal based on the first clock to the first camera so as to trigger the first camera to capture a first image, and acquiring the first image; and
transmitting, by the second image acquisition module, a second hardware trigger signal based on the second clock to the second camera so as to trigger the second camera to capture a second image, and acquiring the second image, wherein synchronization between the first hardware trigger signal and the second hardware trigger signal is achieved by using the clock difference.

13. The image acquisition method according to claim 12, further comprising:
connecting the first image acquisition module to the first camera via a first GPIO interface so as to transmit the first hardware trigger signal to the first camera;
in response to receiving the first hardware trigger signal, by the first camera, initiating exposure and image capture and transmitting an image to the first image acquisition module via a first CSI interface;
connecting the second image acquisition module to the second camera via a second GPIO interface so as to transmit the second hardware trigger signal to the second camera; and
in response to receiving the second hardware trigger signal, by the second camera, initiating exposure and image capture and transmitting an image to the second image acquisition module via a second CSI interface.

14. The image acquisition method according to claim 13, further comprising determining the clock difference between the first wireless communication module and the second wireless communication module in performing the wireless communication respectively through the following:
during the continuous use of the first image acquisition module and the second image acquisition module, enabling one party of the first wireless communication module and the second wireless communication module to transmit a wireless signal to the other party; and determining a value difference between clock counters at a first time point when the one party transmits the wireless signal and at a second time point when the other party receives the wireless signal as the clock difference.

15. The image acquisition method according to claim 13, further comprising determining the clock difference between the first wireless communication module and the second wireless communication module in performing the wireless communication respectively through the following:
during the continuous use of the first image acquisition module and the second image acquisition module, enabling the first wireless communication module and the second wireless communication module to each receive the wireless signal from the smart device; and determining a value difference between the clock counters at a third time point when the first wireless communication module receives the wireless signal and at a fourth time point when the second wireless communication module receives the wireless signal as the clock difference.

16. The image acquisition method according to claim 14, further comprising:
generating the first hardware trigger signal when the value of the clock counter of the first portion is a first predetermined value; and
generating the second hardware trigger signal when the value of the clock counter of the second portion is a second predetermined value, wherein the difference between the first predetermined value and the second predetermined value is set based on the value difference, thereby characterizing the same time point.

17. The image acquisition method according to claim 14, further comprising:
generating a reference hardware trigger signal at the first portion, and acquiring a reference value of the clock counter of the first portion at a trigger time point;
transmitting, via the first wireless communication module, the reference value to the second wireless communication module;
generating the first hardware trigger signal after a predetermined time delay subsequent to the trigger time point;
determining, at the second portion, the value of the clock counter used to generate the second hardware trigger signal based on the reference value, the predetermined time delay and the value difference of the clock counter; and
generating the second hardware trigger signal when the value of the clock counter of the second portion reaches a determined value, so that the first hardware trigger signal and the second hardware trigger signal are generated at the same time point.

18. The image acquisition method according to claim 13, further comprising:
detecting a brightness of ambient light of the first camera and the second camera; and
setting exposure times for the first camera and the second camera, so that the lower the brightness of ambient light, a longer the exposure time of the corresponding camera.

19. The image acquisition method according to claim 18, further comprising:
for the first camera or the second camera, for which a longer exposure time is required to be set, enabling the image acquisition module connected thereto to generate and transmit the corresponding hardware trigger signal a predetermined time in advance of the image acquisition module connected to the other camera.

20. The image acquisition method according to claim 19, wherein the advanced predetermined time is approximately half of an excess amount of the exposure time.
